(19) United States
(12) Patent Application Publication
(10) Pub. No.: US 2007/0263127 A1
(43) Pub. Date: Nov. 15, 2007

(54) Low Noise Gamma Function In Digital Image Capture Systems And Methods

(75) Inventor: Eugene Fainstain, Netania (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: TransChip, Inc., Ramat-Gan (IL)

(21) Appl. No.: 11/683,084

(22) Filed: Mar. 7, 2007

Related U.S. Application Data
(60) Provisional application No. 60/780,130, filed on Mar. 7, 2006.

(51) Int. Cl. H04N 5/202

(52) U.S. Cl. 348/674; 348/E05.074

(57) ABSTRACT

An image processing system includes a filtering arrangement configured to receive incoming pixel information and filter at least a first portion of the information to thereby pass a second portion of the information for further processing, circuitry configured to apply a gamma function to the second portion to thereby produce a modified second portion, and an adder configured to combine the first portion to the modified second portion.

### CROSS-REFERENCES TO RELATED APPLICATIONS

This application is a non-provisional, and claims the benefit, of co-pending, commonly assigned, U.S. Provisional Application No. 60/780,130, filed on Mar. 7, 2006, entitled “LOW NOISE GAMMA FUNCTION,” the entirety of which is herein incorporated by reference for all purposes.

This application is related to the following co-pending, commonly-assigned U.S. patent applications, the entirety of each of which being herein incorporated by reference for all purposes: U.S. patent application Ser. No. 10/474,798, filed Oct. 8, 2003, entitled “CMOS IMAGER FOR CELLULAR APPLICATIONS AND METHODS OF USING SUCH”; U.S. patent application Ser. No. 10/474,275, filed Feb. 11, 2005, entitled “CMOS IMAGER FOR CELLULAR APPLICATIONS AND METHODS OF USING SUCH”; U.S. patent application Ser. No. 10/474,799, filed Oct. 8, 2003, entitled “BUILT-IN SELF TEST FOR A CMOS IMAGER”; U.S. patent application Ser. No. 10/333,942, filed Apr. 29, 2003, entitled “SINGLE CHIP CMOS IMAGE SENSOR SYSTEM WITH VIDEO COMPRESSION”; U.S. patent application Ser. No. 11/101,195, filed Apr. 6, 2005, entitled “METHODS AND SYSTEMS FOR ANTI SHADING CORRECTION IN IMAGE SENSORS”; U.S. patent application Ser. No. 11/107,387, filed Apr. 14, 2005, entitled “SYSTEMS AND METHODS FOR CORRECTING GREEN DISPARITY IN IMAGER SENSORS”; U.S. patent application Ser. No. 11/223,758, filed Sep. 9, 2005, entitled “IMAGE FLICKER COMPENSATION SYSTEM AND METHOD,” which is a non-provisional, and claims the benefit, of U.S. Provisional Application No. 60/609,195, filed Sep. 9, 2004, entitled “IMAGER FLICKER COMPENSATION”; U.S. patent application Ser. No. 11/467,044, filed Aug. 24, 2006, entitled “SMEAR CORRECTION IN A DIGITAL CAMERA,” which is a non-provisional, and claims the benefit, of U.S. Provisional Application No. 60/711,156, filed Aug. 24, 2005, entitled “METHODS AND APPARATUS FOR SMEAR CORRECTION IN A DIGITAL CAMERA; U.S. patent application Ser. No. 11/467,044, filed Aug. 24, 2006, entitled “SMEAR CORRECTION IN A DIGITAL CAMERA,” which is a non-provisional, and claims the benefit, of U.S. Provisional Application No. 60/711,156, filed Aug. 24, 2005, entitled “METHODS AND APPARATUS FOR SMEAR CORRECTION IN A DIGITAL CAMERA; and U.S. patent application Ser. No. 11/674,719, filed Feb. 14, 2007, entitled “POST CAPTURE IMAGE QUALITY ASSESSMENT,” which is a non-provisional, and claims the benefit, of U.S. Provisional Application No. 60/773,400, filed on Feb. 14, 2006, entitled “POST CAPTURE IMAGE QUALITY ASSESSMENT.”

### FIELD OF THE INVENTION

Embodiments of the present invention relate generally to image capture. More specifically, embodiments of the invention relate to systems and methods for processing pixel information in digital image capture.

### BACKGROUND OF THE INVENTION

Gamma function is typically applied to captured images to adjust the linear response of pixels to the exponential response of most display devices. Gamma is also used, however, for other purposes, such as dynamic range extension.

Gamma typically is applied on each incoming pixel. The value may be expressed as: Pₒᵤₜ=Pᵢₙ^{γ}. That is, the output pixel value Pₒᵤₜ is the input pixel value Pᵢₙ raised to the power of Gamma γ. Typically, thought not necessarily, the value of Gamma is 0.45.

Gamma function often is implemented using a lookup table for all possible input values. In some cases, a reduced lookup table is used and intermediate values are interpolated. The latter case yields an approximation of the Gamma function.

For normalized values of Pᵢₙ (i.e., 0>Pᵢₙ>1), Pₒᵤₜ is also between 0 and 1. Hence, a Gamma curve 100 for Gamma=0.7 would appear as in FIG. 1. The curve 110 depicts the value of Pₒᵤₜ, while curve 120 depicts the value of the first derivative of Pₒᵤₜ.

The value of the first derivative 120 is greater than 1 for low values of Pout. Consequently, pixel noise in that area will be increased by the Gamma function, and pixel noise will be decreased for high values of Pₒᵤₜ. In terms of image quality, noise where Pₒᵤₜ is low is much worse than it is when Pₒᵤₜ is high because the ratio of signal to noise is much worse in that range. This is undesirable. Hence, improved Gamma function implementation is needed.

### BRIEF SUMMARY OF THE INVENTION

Embodiments of the invention provide an image processing system. The system includes a filtering arrangement configured to receive incoming pixel information and filter at least a first portion of the information to thereby pass a second portion of the information for further processing, circuitry configured to apply a gamma function to the second portion to thereby produce a modified second portion, and an adder configured to combine the first portion to the modified second portion. The image processing system may include a delay circuitry configured to introduce a processing delay to thereby delay processing of the first portion prior to combining the first portion to the modified second portion. The filtering arrangement may include a spatial low-pass filter. The spatial low pass filter may include a multiplication matrix function. The multiplication matrix function may be applied to a 3×3 pixel region. The spatial low pass filter may include an infinite impulse response filter. The image processing system may be comprised by a digital still camera, camera phone, movie camera, or the like. The circuitry configured to apply a gamma function to the second portion to thereby produce a modified second portion may include a look up table. The circuitry configured to apply a gamma function to the second portion to thereby produce a modified second portion comprises a partial look up table and interpolation circuitry.

Other embodiments provide an image processing system having means for receiving image information from an image sensor, means for segmenting the image information into a first portion and a second portion, means for applying a gamma function to the first portion to produce a modified first portion, and means for combining the second portion to the modified first portion to thereby produce final image information.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 depicts a gamma function curve and its first derivative for gamma=0.45.

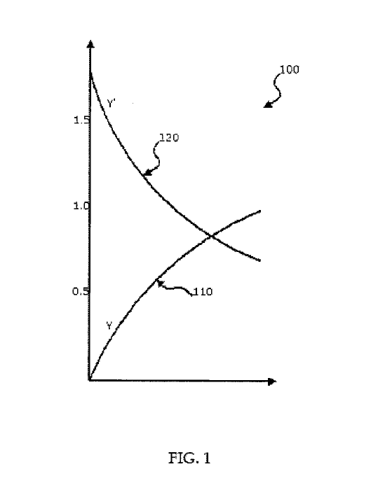

FIG. 2 depicts a circuit that implements a gamma function according to embodiments of the invention.

FIG. 3 depicts a spatial low pass filter function that may be used in embodiments of the present invention.

### DETAILED DESCRIPTION OF THE INVENTION

Embodiments of the present invention relate to capturing images. In order to provide a context for describing embodiments of the present invention, embodiments of the invention will be described herein with reference to digital image capture. Those skilled in the art will appreciate, however, that other embodiments are possible.

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It is to be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems may be shown in block diagrams in order not to obscure the embodiments in unnecessary detail. In other instances, well-known processes, structures and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

According to embodiments of the invention, a gamma function is implemented for pixels generated in an image sensor. The gamma function is implemented by separating the function into a noise-amplifying part and a noise-invariant part. A low pass version of the noise amplifying part is added to the noise-invariant part. Hence, a version of the gamma function is implemented which does not amplify the noise and which does not distort the high spatial frequency of the image.

The low noise gamma function Y=G(X), consists of two parts: the part that does not amplify noise (Y1=X); and the part that does amplify the noise (Y2=X^{γ}−X). A spatial low pass filter is used to reduce the noise in the Y2 part. Although low-pass filtering may decrease the edges of the image, image sharpness is maintained by the Y1 part of the function.

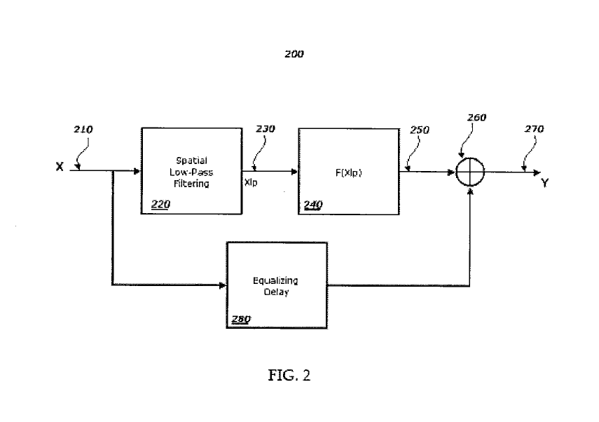

An exemplary embodiment of the present invention is depicted in FIG. 2, which represents a block diagram of a low noise gamma circuit 200. Those skilled in the art will appreciate how to implement the embodiment of FIG. 2 into any of a variety of image capture devices, including digital still cameras, camera phones, video cameras, and the like. The low-noise gamma circuit 200 includes a spatial low-pass filter 220, a Y2 function 240, and an adder 260.

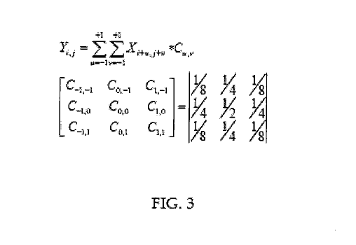

As pixel values X come into the circuit as inputs 210, they enter the spatial low-pass filter 220. In some embodiments the spatial low pass filter 220 includes a multiplication matrix that operates on the 3×3 pixel region centered on the current pixel by multiplying the region by a constant 3×3 matrix. One exemplary matrix is depicted in FIG. 3. In other embodiments, different matrices may be used, with different sizes of the environment. In yet other embodiments, an infinite impulse response (IIR) filter may be used.

Outputs 230 from the spatial low pass filter 220 are provided to an input port of F(X1p) 240, which implements the function Y2=X^{γ}−X. In some embodiments F(X1p) 240 may be implemented using a read-only-memory look-up table. In some other embodiments it may be approximated using a partial look up table coupled with an interpolation circuit for intermediate values not provided by the table. Other embodiments are possible.

Because processing through the spatial low pass filter 220 and F(X1p) 240 may delay the pixel values relative to other pixel values, pixels values received at the input 210 also are provided to an equalizing delay 280. The delayed provided by the equalizing delay 280 is equal to the delay through spatial low pass filter 220 and F(X1p) 240. The output 250 of F(X1p) 240 is then added by adder 260 to the delayed version of the original pixel 210.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. Accordingly, the above description should not be taken as limiting the scope of the invention, which is defined in the following claims.

What is claimed is:

1. An image processing system, comprising:
a filtering arrangement configured to receive incoming pixel information and filter at least a first portion of the information to thereby pass a second portion of the information for further processing;
circuitry configured to apply a gamma function to the second portion to thereby produce a modified second portion; and
an adder configured to combine the first portion to the modified second portion.

2. The image processing system of claim 1, further comprising delay circuitry configured to introduce a processing delay to thereby delay processing of the first portion prior to combining the first portion to the modified second portion.

3. The image processing system of claim 1, wherein the filtering arrangement comprises a spatial low-pass filter.

4. The image processing system of claim 3, wherein the spatial low pass filter comprises a multiplication matrix function.

5. The image processing system of claim 4, wherein the multiplication matrix function is applied to a 3×3 pixel region.

6. The image processing system of claim 1, wherein the spatial low pass filter comprises an infinite impulse response filter.

7. The image processing system of claim 1, wherein the image processing system is comprised by a selection from the group consisting of: digital still camera, camera phone, and movie camera

8. The image processing system of claim 1, wherein the circuitry configured to apply a gamma function to the second portion to thereby produce a modified second portion comprises a look up table.

9. The image processing system of claim 1, wherein the circuitry configured to apply a gamma function to the second portion to thereby produce a modified second portion comprises a partial look up table and interpolation circuitry.

10. An image processing system, comprising:
means for receiving image information from an image sensor;
means for segmenting the image information into a first portion and a second portion;
means for applying a gamma function to the first portion to produce a modified first portion; and
means for combining the second portion to the modified first portion to thereby produce final image information.

11. The system of claim 10, further comprising means for introducing a processing delay to thereby delay processing of the second portion prior to combining the second portion to the modified first portion.

12. The system of claim 10, wherein the means for segmenting the image information into a first portion and a second portion comprises a spatial low-pass filter.

13. The system of claim 11, wherein the spatial low pass filter comprises a multiplication matrix function.

14. The system of claim 13, wherein the multiplication matrix function is applied to a 3×3 pixel region.

15. The system of claim 10, wherein the means for segmenting the image information into a first portion and a second portion comprises an infinite impulse response filter.

16. The system of claim 10, wherein the image processing system is comprised by a selection from the group consisting of: digital still camera, camera phone, and movie camera.

17. The system of claim 10, wherein the means for applying a gamma function to the first portion to produce a modified first portion comprises a look up table.

18. The system of claim 10, wherein the means for applying a gamma function to the first portion to produce a modified first portion comprises a partial look up table and interpolation circuitry.
